(19) United States
(12) Patent Application Publication
(10) Pub. No.: US 2024/0359363 A1
(43) Pub. Date: Oct. 31, 2024

(54) CANTILEVERED CUTTING MACHINE

(71) Applicant: Park Industries, Inc., St. Cloud, MN (US)

(72) Inventors: Martin Bruno, Avon, MN (US); Matthew Grow, Otsego, MN (US); Kevin Kampa, St. Cloud, MN (US); Timothy Swain, Monticello, MN (US); Russell Kerfeld, Sartell, MN (US); Robert Penas, Silver Lake, MN (US)

(21) Appl. No.: 18/647,804

(22) Filed: Apr. 26, 2024

Related U.S. Application Data
(60) Provisional application No. 63/498,906, filed on Apr. 28, 2023.

(51) Int. Cl. B28D 7/04; B28D 7/00

(52) U.S. Cl. CPC B28D 7/043; B28D 7/005

(57) ABSTRACT

A material cutting apparatus that includes a frame, a vertical support member, a cantilevered arm, and a cutting head. The frame has a first end and a second end and a track running between the first end and the second end. The vertical support member is mounted to the track and extends outwardly from the track. The vertical support member terminates at a vertical support member free end, where the vertical support member is configured to travel about the track from the first end to the second end. The vertical support member is rotatable about a vertical axis. The cantilevered arm extends outwardly from and normal to the vertical support member. The cantilevered arm terminates at a cantilever free end. The cutting head is configured to move along the cantilevered arm between the vertical support member and the free end.

### CROSS-REFERENCE TO RELATED APPLICATION

This application claims the benefit of U.S. Provisional Application Ser. No. 63/498,906, filed Apr. 28, 2023, the disclosure of which is hereby incorporated by reference in its entirety.

### BACKGROUND

Cutting machines for shaping stone and similar materials are known in the art. Machines for cutting stone have relatively high cycle-times due, in part, to the heavy and cumbersome nature of loading, positioning, and unloading of stone; and to the significant time it takes for cutting tools to move through hard materials like stone. Stone cutting machines also occupy a significant footprint within a manufacturing facility. Floor space and cycle time contribute directly and significantly to operation cost.

Improvements to footprint and cycle time of cutting machines are therefore desired.

### SUMMARY

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

Aspects of the present disclosure relate to a material cutting apparatus that includes a frame with a first end and a second end. The frame has a track running between the first end and the second end. The material cutting apparatus also includes a vertical support member mounted to the track that extends outwardly from the track. The vertical support member terminates at a vertical support member free end, where the vertical support member is configured to travel about the track from the first end to the second end. The vertical support member is rotatable about a vertical axis that extends along a length of the vertical support member between the track and the vertical support member free end. The material cutting apparatus also includes a cantilevered arm that extends outwardly from and normal to the vertical support member. The cantilevered arm terminates at a cantilever free end. The material cutting apparatus also includes a cutting head with a rotational member configured to move along the cantilevered arm between the vertical support member and the cantilever free end. The rotational member is configured to physically contact the material during material processing. In certain examples, the vertical support member is configured to rotate in a travel range of about 180 degrees about the vertical axis such that the cantilever may extend outwardly from a first side or a second side of the track. In certain examples, the rotational member is mounted directly below the cantilevered arm. In certain examples, the rotational member includes a blade. In certain examples, the rotational member includes a routing bit. In certain examples, the cutting head further includes a water jet. In certain examples, the vertical support member includes radial bellows. In certain examples, the cutting head includes rotatable cable guides about the perimeter of the cutting head.

Another aspect of the present disclosure relates to a material cutting apparatus that includes a frame, a vertical support member, a cantilevered arm, a cutting head, and a control arrangement. The frame includes a first end and a second end and has a track running between the first end and the second end. The vertical support member mounts to the track and extends outwardly from the track. The vertical support member terminates at a vertical support member free end. The vertical support member is configured to travel about the track from the first end to the second end. The vertical support member is rotatable about an axis that extends along a length of the vertical support member between the track and the vertical support member free end. The cantilevered arm extends outwardly from and normal to the vertical support member. The cantilevered arm terminates at a cantilever free end. The cutting head includes a cutting member configured to move along the cantilevered arm between the vertical support member and the cantilever free end. The control arrangement may be integrally mounted to the first end of the frame. In certain examples, the control arrangement includes a control panel. In certain examples, the control arrangement is attached to the material cutting apparatus using a mount. In certain examples, the control arrangement includes a control screen. In certain examples, the control arrangement facilitates remote control of the material cutting apparatus.

Another aspect of the present disclosure relates to a material cutting apparatus that includes a frame, a vertical support member, a cantilevered arm, a cutting head, and a modular worktable. The frame includes a first end and a second end. The frame has a track running between the first end and the second end. The vertical support member mounts to the track and extends outwardly from the track. The vertical support member terminates at a vertical support member free end. The vertical support member is configured to travel about the track from the first end to the second end. The vertical support member is rotatable about an axis that extends along a length of the vertical support member between the track and the vertical support member free end. The cantilevered arm extends outwardly from and normal to the vertical support member. The cantilevered arm terminates at a cantilever free end. The cutting head includes a cutting member configured to move along the cantilevered arm between the vertical support member and the cantilever free end. The modular worktable may be removably positioned at a first side of the frame. When positioned, the modular worktable extends in a first direction at least partially along the frame between the first and second ends. The modular worktable extends outwardly away from the frame and normal to the vertical support member. In certain examples, a second modular worktable may be removably positioned at a second side of the frame. When positioned, the second modular worktable extends in the first direction at least partially along the frame between the first and second ends. The second modular worktable extends outwardly away from the frame and normal to the vertical support member in an opposite direction from the first modular worktable.

In certain examples, the modular worktable further includes a table frame, a movable support surface, a first link, a second link, an actuator, and a fluid tank. The movable support surface is pivotally mounted to the table frame where the support surface is configured for supporting the material. The first link extends between the support surface and the table frame. The first link is pivotally connected to the support surface at a first end of the first link and pivotally connected to the table frame at a second end of the first link. The second link extends between the support surface and the table frame. The second link is pivotally connected to the support surface at a first end of the second link and pivotally connected to the table frame at a second end of the second link. The actuator is pivotally connected to the table frame. The actuator is configured to move the support surface between a generally horizontal position and a generally vertical position. The fluid tank is positioned under the support surface when the support surface is in the generally horizontal position. In certain examples, the support surface pivots and translates with respect to the table frame when the support surface moves between the generally horizontal position and the generally vertical position. In certain examples, the support surface includes a metallic grid positioned over the fluid tank when the support surface is in the generally horizontal position. In certain examples, the material loading apparatus may include a pair of first links, a pair of second links, and a pair of actuators. In certain examples, each actuator includes a ram. The rams are pivotally connected to the second links at locations between the first ends and the second ends of each second link.

Another aspect of the present disclosure relates to a cutting apparatus that includes a frame, a vertical support member, a cantilevered arm, and a cutting head. The frame includes a first end and a second end. The frame has a track running between the first end and the second end. The vertical support member is mounted to the track and extends outwardly from the track. The vertical support member terminates at a vertical support member free end. The vertical support member is configured to travel about the track from the first end to the second end. The cantilevered arm extends outwardly from and normal to the vertical support member. The cantilevered arm terminates at a cantilever free end. The cutting head includes a rotational member configured to move along the cantilevered arm between the vertical support member and the cantilever free end. The cutting head is configured to allow varying a cutting angle of the rotational member relative to the cantilevered arm.

### BRIEF DESCRIPTION OF THE DRAWINGS

The accompanying drawings, which are incorporated in and constitute a part of the description, illustrate several aspects of the present disclosure. A brief description of the drawings is as follows.

FIG. 1 is a perspective view of a material cutting assembly in accordance with the principles of the present disclosure.

FIG. 2 is a front view of the material cutting assembly of FIG. 1.

FIG. 3 is a perspective view of a material cutting apparatus in a home position in accordance with the principles of the present disclosure.

FIG. 4 is a side view of the material cutting apparatus of FIG. 3.

FIG. 5 is a top view of the material cutting apparatus of FIG. 3.

FIG. 6 is another perspective view of the material cutting apparatus of FIG. 3 in a rotated position.

FIG. 7 is a side view of the material cutting apparatus of FIG. 6.

FIG. 8 is a front view of the material cutting apparatus of FIG. 6.

FIG. 9a is a perspective view of a cutting head from the material cutting apparatus of FIG. 4 with a rotational member at 90 degrees.

FIG. 9b is a perspective view of a cutting head from the material cutting apparatus of FIG. 6 where rotational member is rotated relative to that shown in FIG. 9a.

FIG. 9c is a perspective view of a cutting head from the material cutting apparatus of FIG. 6 where the cutting head and rotational member are rotated relative to that shown in FIG. 9a.

FIG. 9d is a perspective view of a cutting head from the material cutting apparatus of FIG. 6 where the cutting head and rotational member are rotated relative to that shown in FIG. 9a.

FIG. 10a is a front view of the cutting head of FIGS. 9a-9d where a waterjet portion is in an upward position.

FIG. 10b is a front view of the cutting head of FIGS. 9a-9d where the waterjet portion is in a downward position.

FIG. 11a is a perspective view of a modular worktable in accordance with the principles of the present disclosure that can be used with the material cutting assembly of FIG. 1.

FIG. 11b is a perspective view of the modular worktable of FIG. 11a where a movable support surface is illustrated in a pivoted position.

FIG. 12 is a side view of the modular worktable of FIG. 11b.

FIG. 13 is a front view of the material cutting apparatus of FIG. 3 shown with the modular worktable of FIG. 11a.

FIG. 14 is another front view of the material cutting apparatus of FIG. 3 with the modular worktable of FIG. 11a, where the cutting head of the material cutting apparatus is in a lowered position.

FIG. 15 is a perspective view of a control arrangement in accordance with the principals of the present disclosure that can be used with the material cutting assembly of FIG. 1.

FIG. 16 is a front view of the material cutting apparatus of FIG. 1 with the control arrangement of FIG. 15 mounted thereto.

FIG. 17 is a side view of the material cutting apparatus of FIG. 1 with the control arrangement of FIG. 15 mounted thereto.

FIG. 18 is a perspective view of a rotatable cable guide in accordance with the principles of the present disclosure that can be used about the perimeter of the cutting head of the material cutting apparatus of FIG. 1.

FIG. 19 is a perspective view of the cable guide of FIG. 18 that is in a different rotational configuration.

FIG. 20 is a perspective view of a radial bellow that can be used on the vertical support member of the material cutting apparatus of FIG. 1, the radial bellow shown in an extended position in accordance with the principles of the present disclosure.

FIG. 21 is a perspective view of the radial bellow of FIG. 20, shown in a retracted position.

### DETAILED DESCRIPTION

Reference will now be made in detail to exemplary aspects of the present disclosure that are illustrated in the accompanying drawings. Wherever possible, the same reference numbers will be used throughout the drawings to refer to the same or like parts.

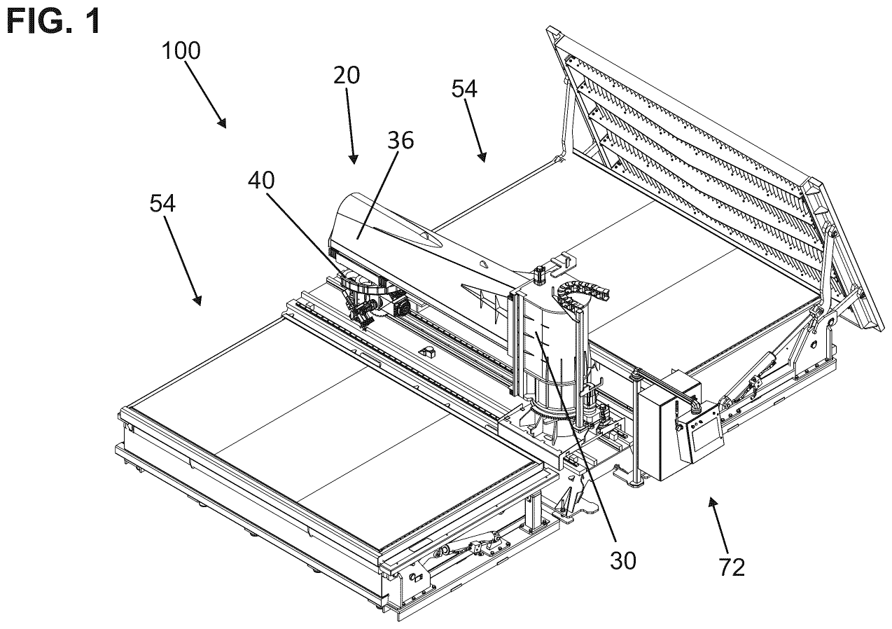

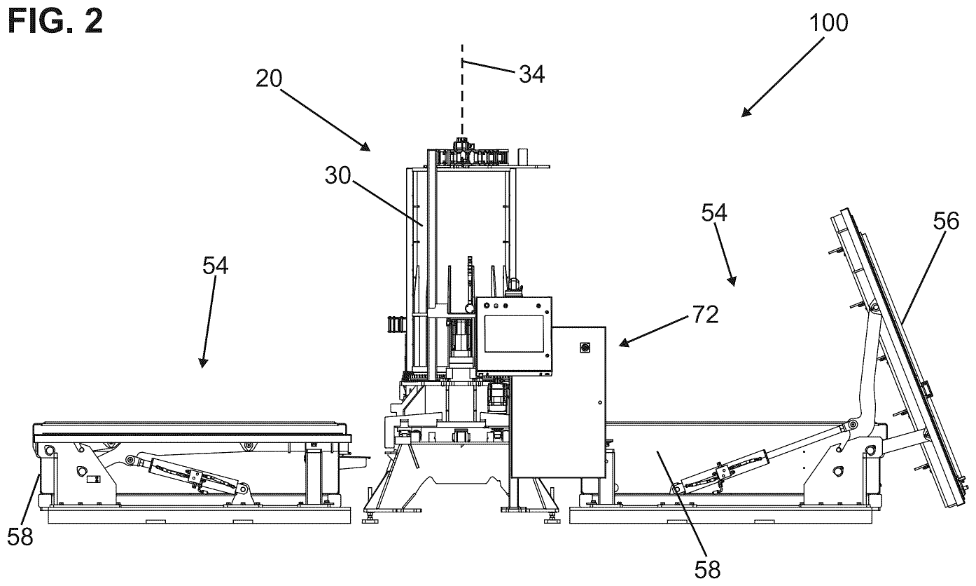

FIGS. 1 and 2 illustrate a material cutting assembly 100 in accordance with the principles of the present disclosure. The material cutting assembly 100 may include any number of components or accessories to facilitate the loading, cutting, and unloading of material. FIG. 1 shows the material cutting assembly 100 with a material cutting apparatus 20, two modular worktables 54, and a control arrangement 72. Each will be discussed in turn.

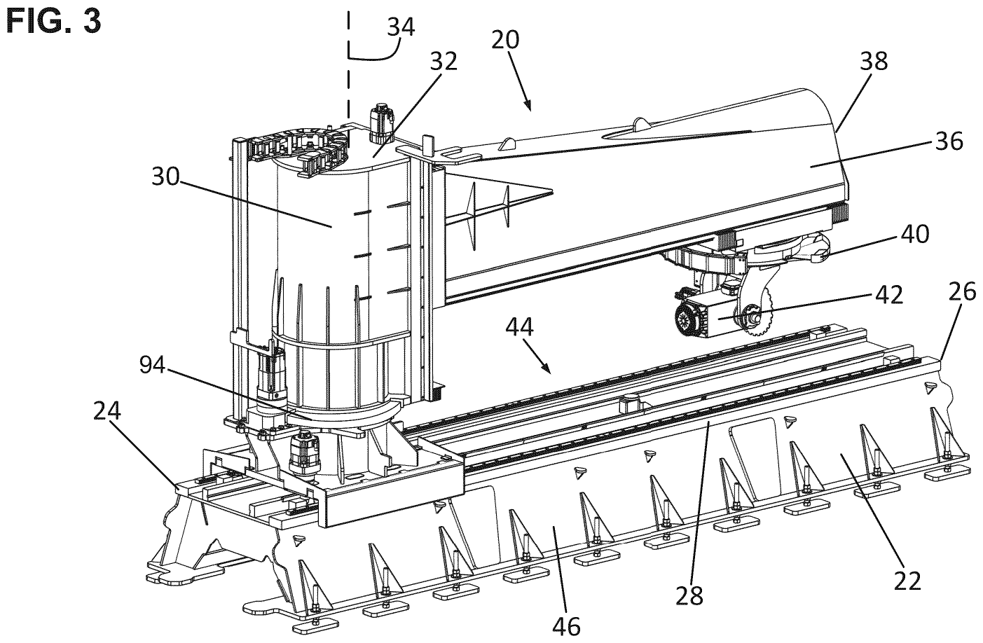

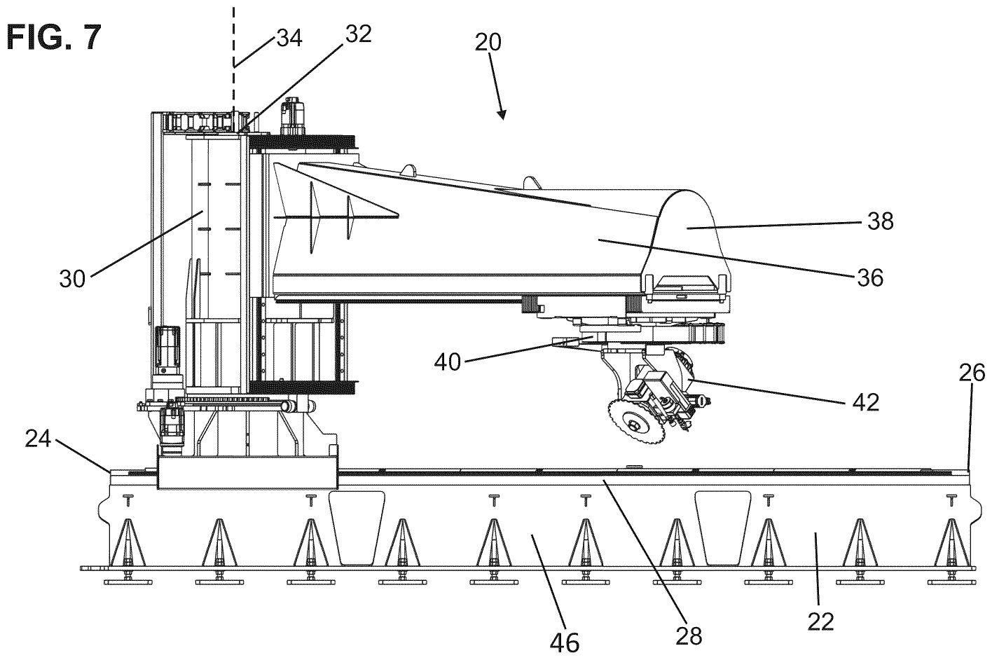

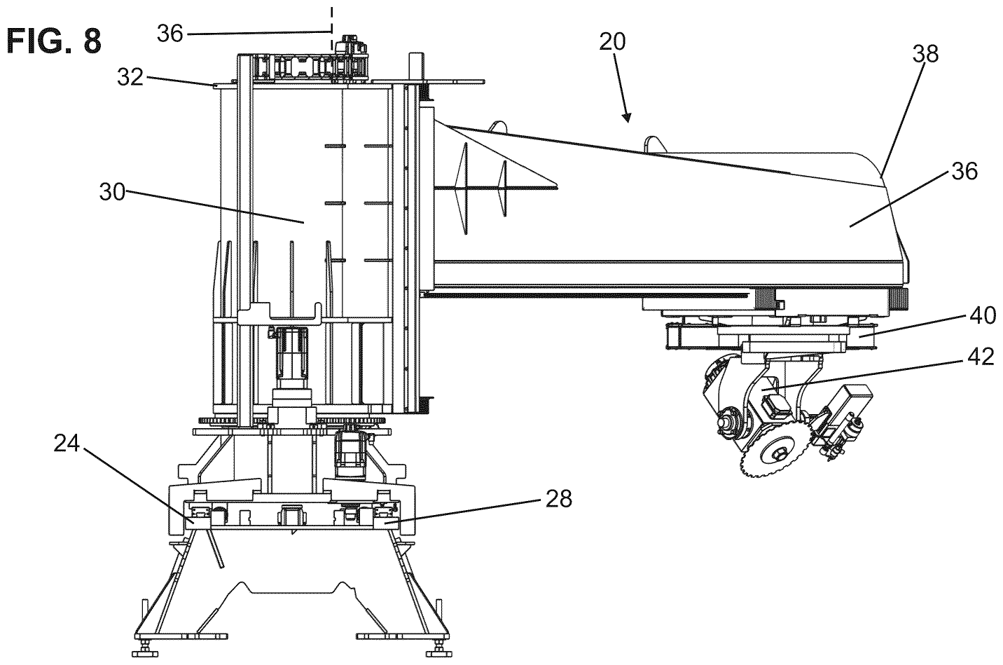

FIGS. 3-8 illustrate the material cutting apparatus 20 of the assembly 100 in accordance with the principles of the present disclosure. The material cutting apparatus 20 may be configured to cut any number of materials, including granite, marble, sandstone, brick, limestone, concrete, cement, porcelain, quartzite, wood, glass, etc. In one example, as shown in FIG. 3, the material cutting apparatus 20 includes a frame 22, a vertical support member 30, a cantilevered arm 36, and a cutting head 40.

The frame 22 extends laterally across a floor or other support surface and has a first end 24 and a second end 26. The frame 22 may be mounted directly to a floor or use a plurality of feet to assist with leveling the frame 22 across a floor. The frame 22 may be of any construction sufficient to support the vertical support member 30 and cantilevered arm 36. In FIG. 3, the frame 22 is constructed of sheet metal, such as steel or aluminum. A track 28 runs laterally along an upper portion of the frame 22 and extends between the first and second ends 24, 26. The track 28 may be defined by two parallel members with one member on a first side 44 and one member on a second side 46 of the frame 22. Other configurations are possible as well. For instance, the track 28 may have a single member, or be integrated directly into the frame 22. The track 28 may be a linear guide track system. Linear guide track systems are designed to enable smooth, precise, and low-friction linear movement. The track 28 may also use a rack and pinion system alone or in conjunction with a linear guide. The track 28 may also use a ball screw. These systems can combine in any fashion to facilitate accurate and consistent motion while minimizing backlash. The frame 22 and track 28 may extend any length depending upon the desired assembly layout. In FIG. 3, the frame 22 and track 28 extend the same length. In other examples, the frame 22 may extend beyond the track 28 or the track 28 may extend beyond the frame 22. The length of the frame 22 may depend on the size of material to be cut and on space constraints. In one example, the frame 22 extends to a length between ten and twenty feet from the first end 24 to the second end 26. The frame 22 also has a width extending from the first side 44 to the second side 46. The width of the frame 22 may also vary. In one example, the width is between three and five feet. The track 28 carries the vertical support member 30 and enables the vertical support member 30 to travel about the track 28 from the first end 24 to the second end 26.

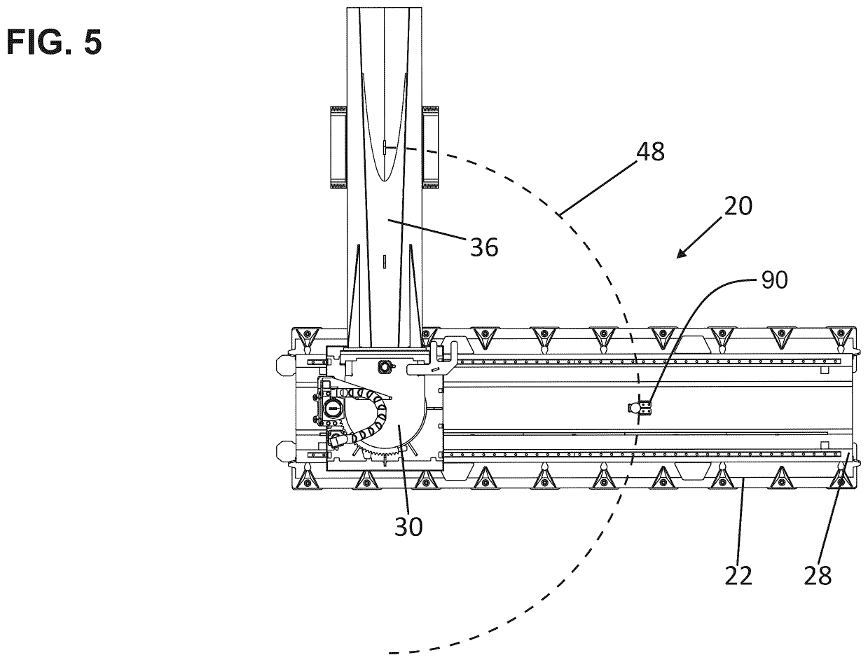

The vertical support member 30 extends vertically from the track 28 about a vertical axis 34 to a free end 32. The vertical support member 30 supports the cantilevered arm 36 which extends laterally away from the vertical support member 30. The vertical support member 30 may rotate about the vertical axis 34 such that the cantilevered arm 36 may move between the first and second sides 44, 46 of the frame 22. In certain examples, the vertical support member 30 may rotate 180 degrees about the vertical axis 34. When the vertical support member 30 rotates, the cantilevered arm 36 moves about path 48, shown in FIG. 5, which centers on the vertical axis 34. It is contemplated that the vertical support member 30 could rotate more or less, including 360 degrees or endless rotation.

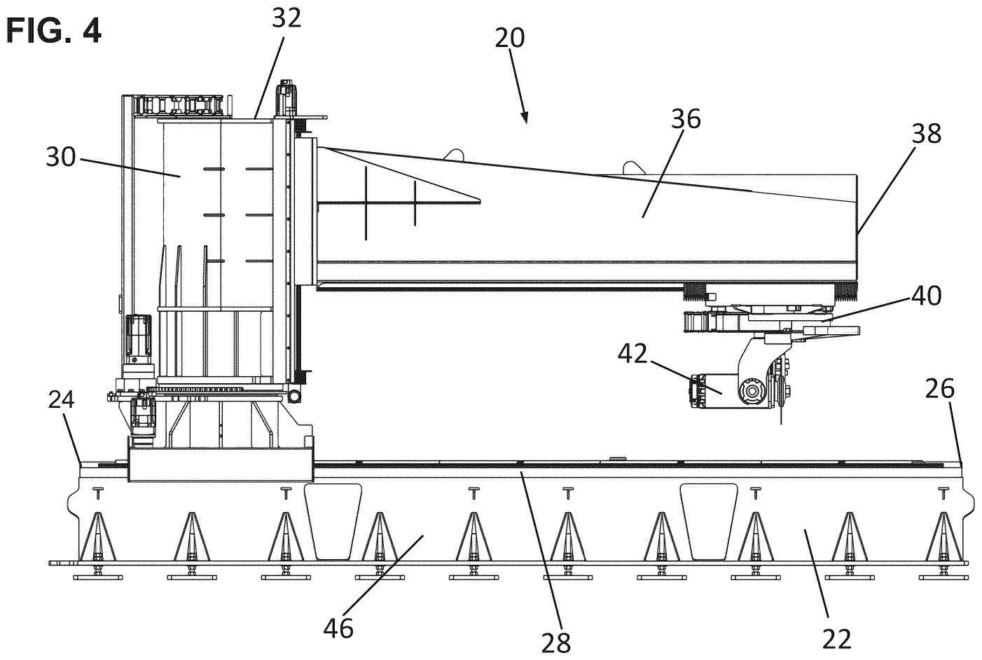

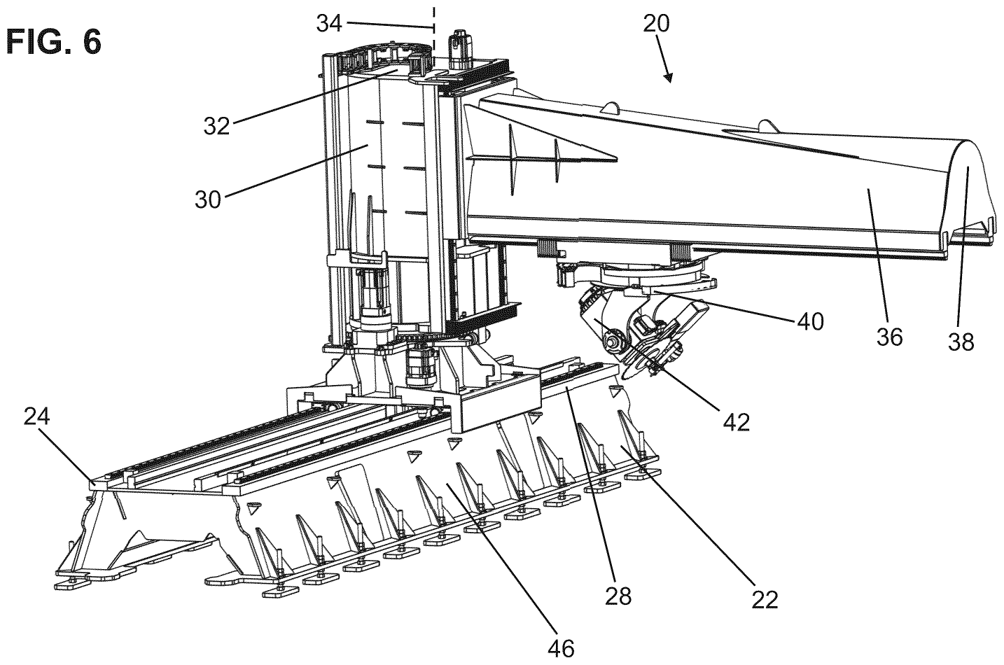

FIG. 6 illustrates how the vertical support member 30 may move about the track 28 and rotate about the vertical axis 34. The vertical support member 30 may also include means for raising and lowering the cantilevered arm 36. For example, the cantilevered arm 36 may raise and lower by a track system, similar to track 28 on the frame 22. The vertical support member 30 may also raise and lower the cantilevered arm 36 by use of a ball screw. The cantilevered arm 36 remains in a parallel plane relative to the frame length during operation. When the vertical support member 30 is positioned near the first end 24 of the frame 22 and the cantilevered arm 36 extends parallel with the frame 22, the material cutting apparatus 20 is defined to be in a home position. FIGS. 3 and 4 show the machine cutting apparatus in the home position.

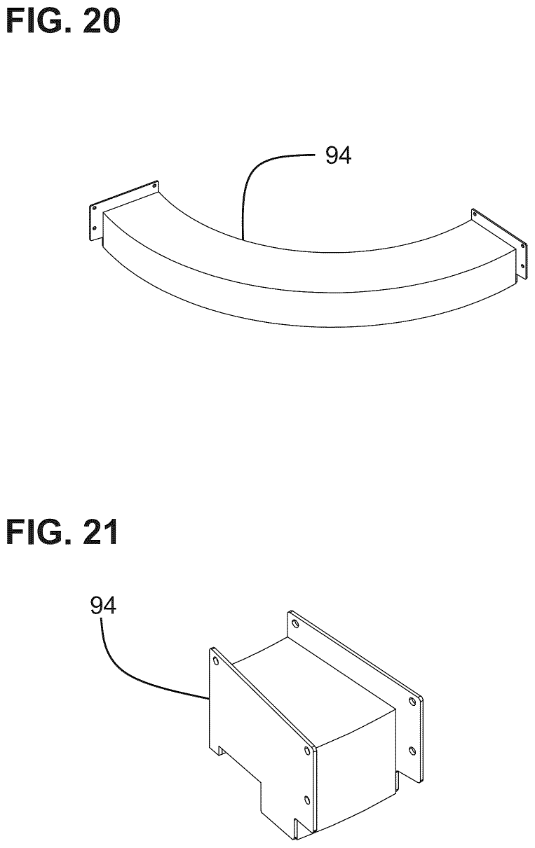

The vertical support member 30 may further include radial bellows 94, as shown in FIGS. 20 and 21. Bellows are commonly employed on linear systems to protect gears and other components from dust or debris. In this example, the radial bellow behaves similarly in that it can move between a retracted state (FIG. 21) and an extended state (FIG. 20) as the vertical support member 30 rotates. FIG. 3 shows the bellows located near a base of the vertical support member 30 which protects the rotational gears and other components during rotation of the vertical support member 30. The radial bellows 94 may be used as a pair such that when one retracts, the other extends and vice versa. For instance, if the vertical support member 30 rotates 90 degrees clockwise, a first side bellow would extend and a second side bellow would retract. Similarly, if the vertical support member 30 rotates 90 degrees counterclockwise, the first side bellow would retract and the second side bellow would extend. In this way, rotational precision can be maintained by avoiding dust and debris from entering the positioning equipment.

The cantilevered arm 36 extends from the vertical support member 30 to a cantilever free end 38. Preferably, the cantilevered arm 36 is designed to minimize deflection across the length of the arm. Enabling the vertical support member 30 to raise and lower the cantilevered arm 36 (as opposed to using a separate system attached to the arm to raise and lower the cutting head) reduces the weight and quantity of components needed on the cantilevered arm 36 to facilitate operation. This configuration, in turn, reduces the weight and deflection of the cantilevered arm 36.

The cantilevered arm 36 may include any number of different end-of-arm tooling features. For example, the cantilevered arm 36 could include vacuum cups, grippers, grinders, welders, painters, lasers, cameras, inspection probes, milling tools, etc. In one example, the cantilevered arm 36 includes the cutting head 40. The cutting head 40 may be positioned, and, in certain embodiments, centered below the cantilevered arm 36. By centering the cutting head 40 below the cantilevered arm 36, twist and torque on the cantilevered arm 36 are reduced. Centering the cutting head 40 also reduces the footprint of the material cutting apparatus 20 in the home position. The length of the cantilevered arm 36 may be provided based on the desired layout. The cantilevered arm 36 may extend longer or shorter than the second end 26 of the frame 22 when the material cutting apparatus 20 is in the home position.

The cutting head 40 is capable of moving along the cantilevered arm 36 from the vertical support member 30 to the cantilever free end 38. FIG. 6 shows the cutting head 40 travelling on a track system, similar to the track 28 on the frame 22.

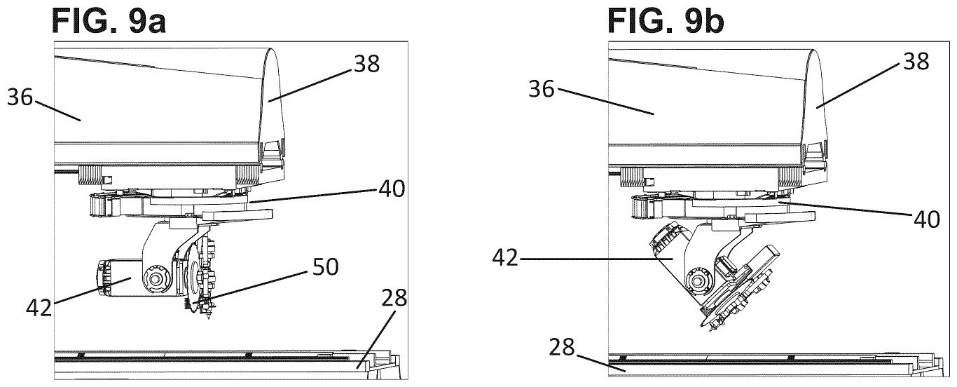

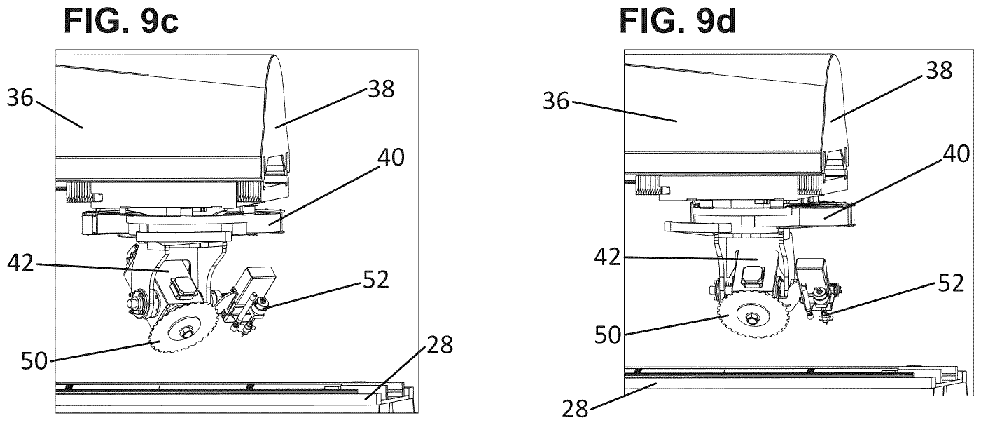

FIGS. 9a-9d show the cutting head 40 in a number of different positions, as examples of the rotational capabilities of the cutting head 40. The cutting head 40 is able to rotate on an axis parallel to, but offset from, the vertical axis 34.

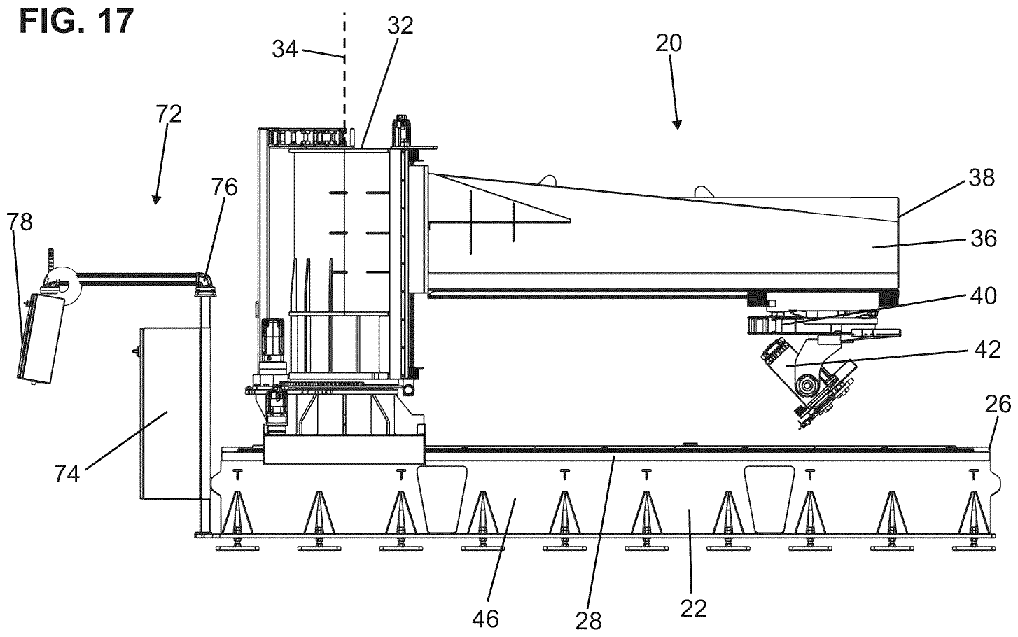

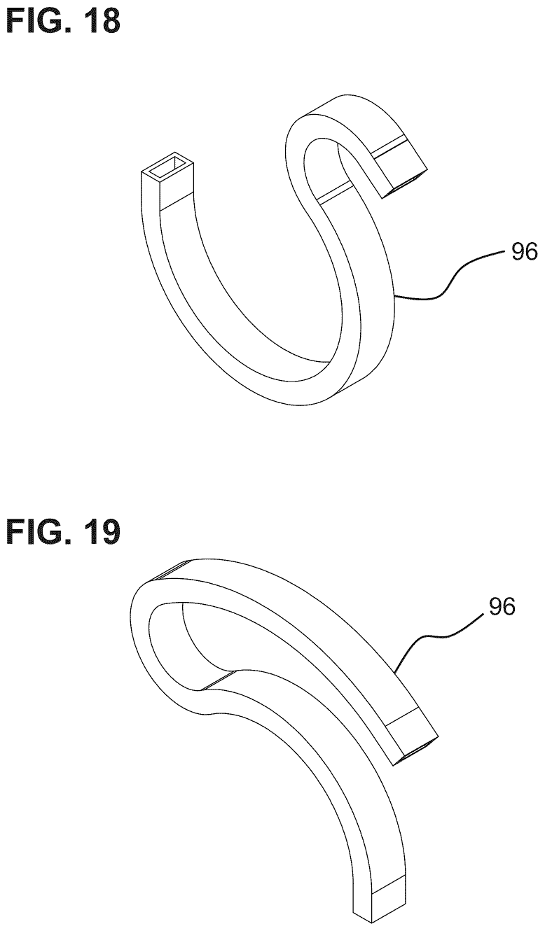

On typical cutting machines, the power, water, or other cables needed for the cutting head 40 may be routed through the center of the cutting head 40 down to cutting members. In the example shown on FIGS. 9a-9d, the cutting head 40 routes the cables and conduits on an outside perimeter of the cutting head 40 instead of down through the center. In this example, energy chains (e-chains) or cable carriers are used to manage the cables. FIGS. 18 and 19 show a couple different states that a cable carrier 96 may take as the cutting head 40 rotates. The cable carrier 96 may form a double bend (FIG. 18) in order to accommodate the rotation of the cutting head 40. By routing cables and conduits to the outside perimeter of the cutting head 40, vertical space is saved, which allows the cutting head 40 to be positioned tight against the cantilevered arm 36.

The cutting head 40 may be equipped with a variety of shaping, polishing, cutting and positioning tools. In the depicted example, the cutting head 40 includes a rotational member 42. The rotational member 42 may rotate on an axis that is normal to the vertical axis 34.

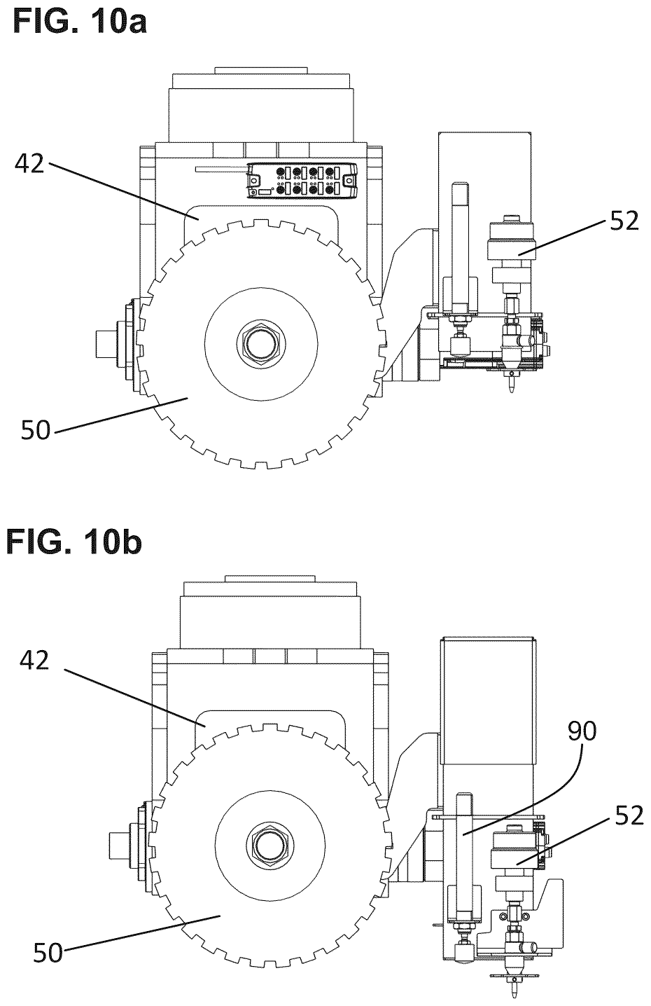

The rotational member 42 may be any number of different shaping, polishing, and cutting tools. For example, the rotational member 42 may be a blade, router, routing bit, grinder, sander, milling machine, other rotary tool, etc. In FIGS. 10a and 10b, the cutting head 40 is shown with a blade 50, as the rotational member 42, and a waterjet 52. The size, type, and rotational speed of blade 50 vary with the material being cut. Similarly, the specifications of the waterjet 52 may vary depending on the material being cut. The cutting head 40 enables a cutting tool to cut at a variety of angles. For example, the rotational member 42 may cut at 30 degrees, 45 degrees, 90 degrees, 120 degrees, 135 degrees, etc. relative to a lateral cutting surface. The rotational member 42 is capable of cutting at angles outside of the described examples as well.

In operation, the vertical support member 30 lowers the cantilevered arm 36 until the rotational member 42 is at the desired height to cut a material. The rotational member 42 physically contacts the material during material processing. In certain instances, one or all of the cutting head 40, vertical support member 30, and cantilevered arm 36 may continue to move during the cutting process. The combined mobility and rotation of the vertical support member 30, the cantilevered arm 36, the cutting head 40, and the rotational member 42 enables six-axis cutting capability. Six-axis cutting capabilities improve the speed and flexibility of cutting operations while also enabling the shaping of complex geometries.

The different apparatus members (e.g., vertical support member 30, cutting head 40, and rotational member 42) can maintain rotational accuracy in a variety of ways. For example, rotational accuracy can be maintained using single or dual encoders, mechanical stops, or combinations of these. The material cutting apparatus 20 can be operated fully on a cartesian system which improves precision and ease of programming over other designs such as robotic arms that require more complex coordinate systems and have difficulty maintaining position when loaded in an outstretched manner.

The cantilever design of the material cutting apparatus 20 eliminates the need for arm support on the second end 26 of the frame 22, which results in a reduced length. Many saws use a bridge or gantry design to support movement of a cutting carriage or otherwise fix a cutting apparatus. These designs require vertical supports on both ends of a bridge. By eliminating the need for a second support end, the footprint of cantilever systems, such as the material cutting apparatus 20, can be reduced.

Positioning and measurement equipment may also be included on the material cutting apparatus 20 in order to further improve accuracy and precision in cutting. For example, there may be positioning and measurement equipment included on the cutting head 40 or the rotational member 42. These tools may be used in a variety of ways, including to measure blade 50 diameter or thickness, locate cutting surfaces, and for calibration purposes.

FIGS. 10a and 10b show a measurement tool 90 positioned near the waterjet 52 and blade 50. Additional measurement equipment may be included on the frame 22. Measurement equipment on the frame 22 can similarly be used to calibrate the material cutting apparatus 20, determine blade 50 diameter, determine waterjet 52 position, and help determine cutting material thickness.

FIG. 5 shows frame measurement tool 92 centered along the frame 22. The frame measurement tool 92 is capable of extending and retracting in order to rise above and below the track 28. During measurement, frame measurement tool 92 rises above the track 28 and during cutting, the frame measurement tool 92 retracts below the track 28. These are only some examples of the ways measurement equipment can be used to improve the precision and accuracy of material cutting apparatus 20.

As referenced above, the material cutting assembly 100 may include one or more cutting tables. For example, it is possible to arrange tables on all sides of the material cutting apparatus 20. In one example, there is a single table positioned on either side of the frame 22. The table may be physically mounted to the frame 22 or may be positioned near the frame 22 but without contacting the frame 22.

Cutting tables can help position the material to be cut. Cutting tables can be linked to the cutting apparatus or independent. In FIGS. 1 and 2, a modular worktable 54 is shown. The modular worktable 54 is independently positioned near the material cutting apparatus 20. The modular worktable 54 may be any form of table suitable for the material to be cut. For example, the modular worktable 54 may be of a simple design with legs and a support surface.

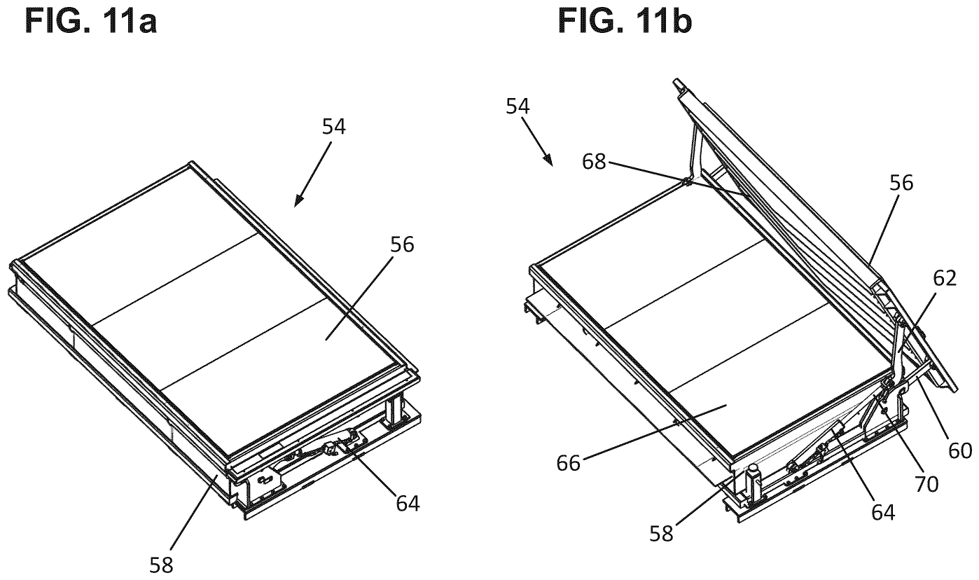

FIGS. 11a and 11b show an example modular worktable 54 in isolation that can be used with the assembly 100 described above. The example worktable 54 includes a table frame 58, a movable support surface 56, and an actuator 64 to rotate the movable support surface 56. The movable support surface 56 facilitates loading and unloading by raising and lowering between a generally horizontal state and a generally vertical state. The movable support surface 56 is pivotally connected to the table frame 58. The actuator 64 controls the movement of the movable support surface 56. Below the movable support surface 56, a fluid tank 66 may be positioned. The fluid tank 66 may collect water (and debris) created by waterjet 52. The fluid tank may dissipate energy from the waterjet stream. A metallic grid 68 enables water and small particles or debris to travel below the movable support surface 56. The fluid tank 66 may also help transfer heat generated during the cutting process. The heat transfer is facilitated by the metallic grid 68 positioned on the underside of the movable support surface 56 such that when the movable support surface 56 is in a flat state, the metallic grid 68 can contact the fluid in fluid tank 66.

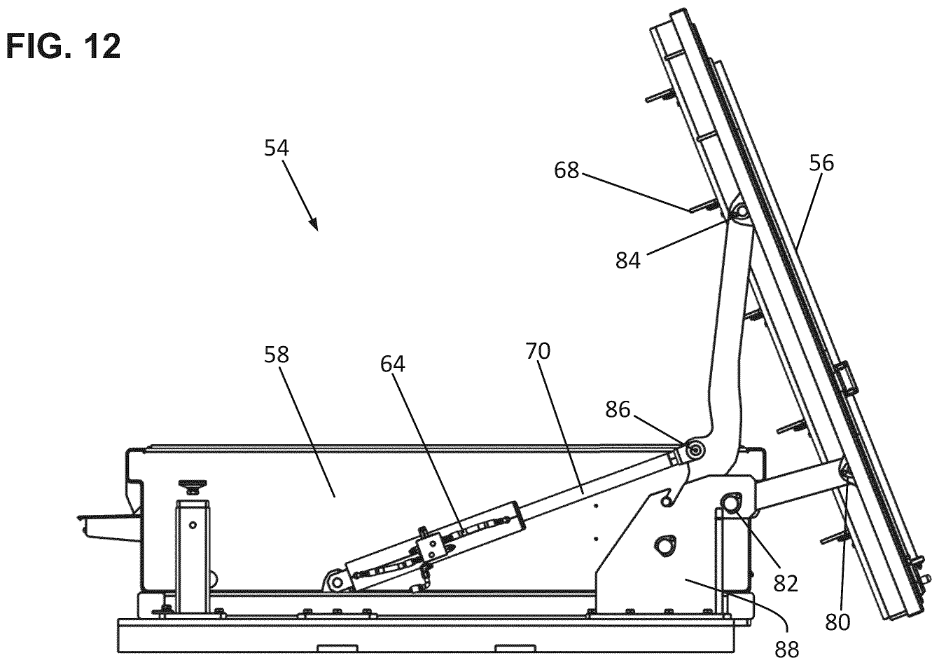

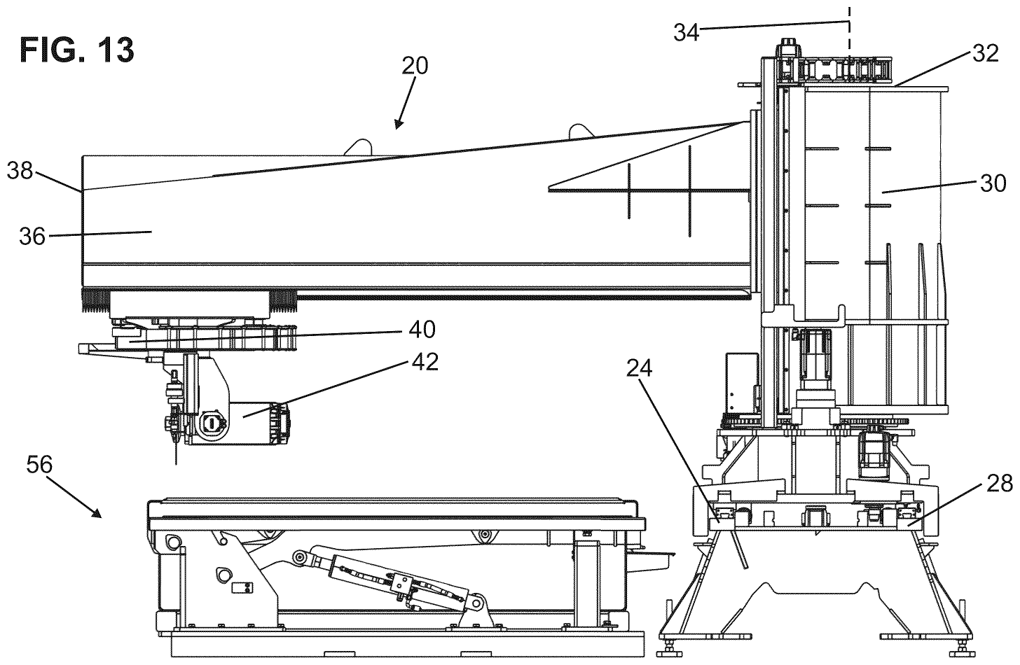

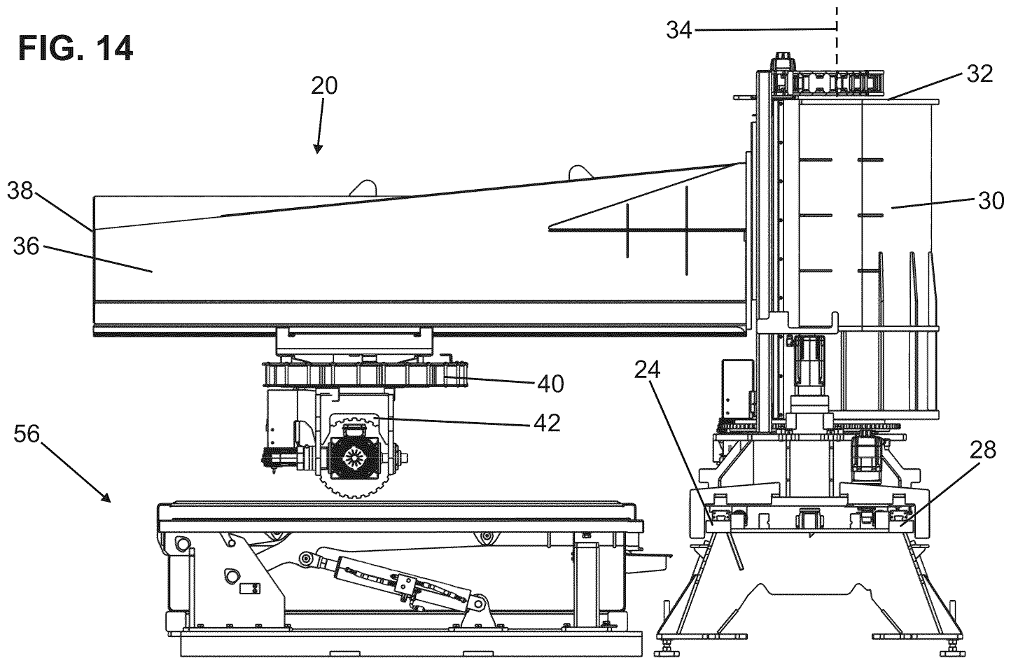

The movable support surface 56 is raised and lowered by at least one actuator 64. In FIGS. 11a and 11b, there are two actuators 64 shown on opposite sides of table frame 58. The movable support surface 56 connects to the table frame 58 by first and second links 60, 62 on opposite sides of the table frame 58 and on the same sides as the actuators 64. First link 60 connects to the movable support surface 56 at a first table link end 80 and the first link 60 connects to the table frame 58 at a first frame link end 82. The second link 62 connects to the movable support surface 56 at a second table link end 84 and the second link 62 connects to the table frame 58 at a second frame link end 86. First and second table link ends also connect to a link mount 88. The actuator 64 extends and retracts a ram 70 which connects to the second link 62 such that when the ram 70 extends, the second link 62 pivots about the link mount 88 and raises to an angled position, as shown in FIG. 12. Such features and functionality of the modular worktable 54 are discussed in further detail in U.S. Pat. No. 10,201,914, incorporated by reference in its entirety.

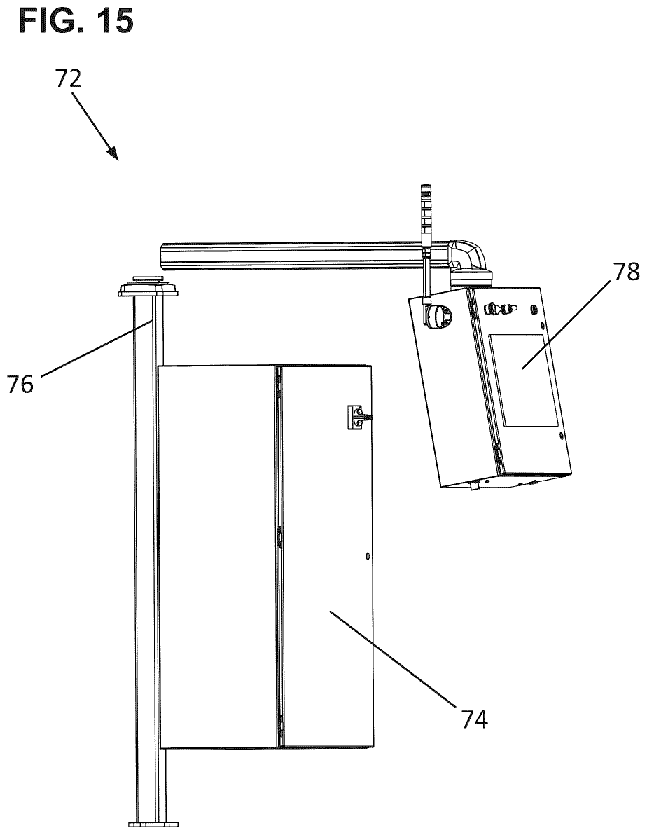

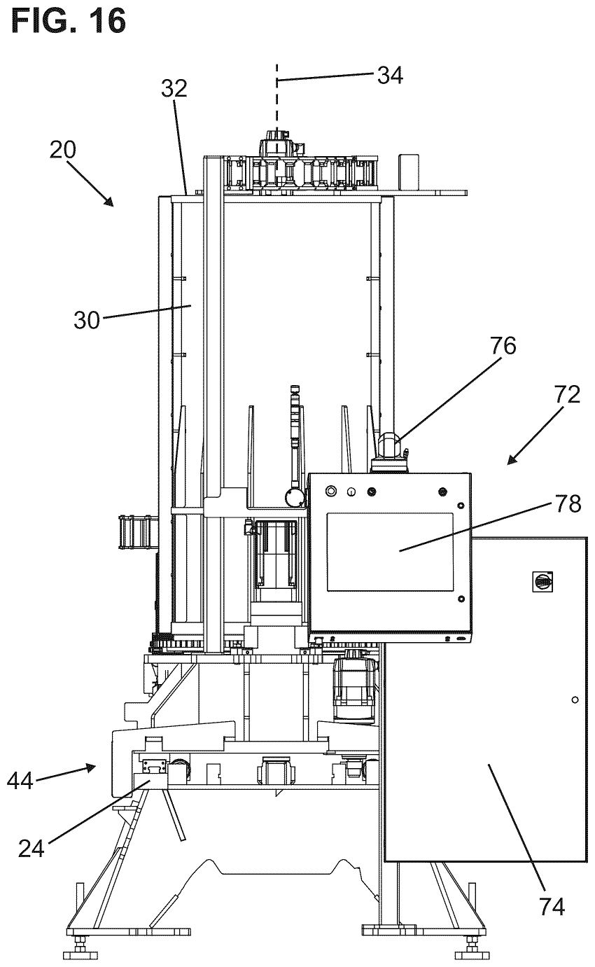

Referring to FIGS. 15-17, the material cutting assembly 100 may also include a control arrangement 72. The control arrangement 72 may include a control panel 74, a control screen 78, and a mount 76. The control arrangement 72 is preferably fixed to the material cutting apparatus 20 at one end of the frame 22. By positioning the control arrangement 72 at the first end 24 or second end 26 of the material cutting apparatus 20, the overall footprint needed to operate the material cutting apparatus 20 is minimized. An operator may be safely present on the first end 24 of the material cutting apparatus 20 during operation of the rotational member 42.

The control panel 74 may include equipment and controls related to the material cutting apparatus 20, accessories for the machine cutting assembly, or for the facility in which the assembly is operated. The size and position of the control panel 74 may vary depending on the space needed. The control screen 78, or a similar control board, may be positioned on the control arrangement 72 such that an operator could run the equipment in a safe position.

It is also contemplated that the material cutting assembly 100 may run fully autonomously and without need for direct operator control. In one example, a control screen 78, or other device may not be necessary or may be used to facilitate remote control of the material cutting apparatus 20 and/or the worktables 54.

The control arrangement 72 can be physically mounted to the material cutting apparatus 20 with a mount 76. FIG. 17 shows the mount 76 fixed to a base of the frame 22. The mount 76 may be attached to the material cutting apparatus 20 any number of ways. For example, the control arrangement 72 may be connected to the material cutting apparatus 20 by a horizontal mount 76. The control arrangement 72 may also be positioned near the material cutting apparatus 20 without being fixed to the material cutting apparatus 20.

The modular arrangement of the assembly 100 provides certain advantages. As shown in FIGS. 1 and 2, the material cutting assembly 100 may operate with a modular worktable 56 on both the first side 44 and the second side 46 of the material cutting apparatus 20. By using two tables in this configuration, the cutting cycle time may be reduced. While the material cutting apparatus 20 cuts a desired material on one side, the other side may be unloaded and reloaded with material to be cut. For example, when the material cutting apparatus 20 completes cutting on the first side 44, the cantilevered arm 36 can rotate about the path 48 and begin cutting on the second side 46, thereby keeping the material cutting apparatus 20 running nearly continuously. In another example two modular worktables 56 are arranged on the same side of material cutting apparatus 20, such that unloading can take place on one modular worktable 56 while cutting takes place on the other modular worktable 56.

Having described the preferred aspects and implementations of the present disclosure, modifications and equivalents of the disclosed concepts may readily occur to one skilled in the art. However, it is intended that such modifications and equivalents be included within the scope of the claims which are appended hereto.

We claim:

1. A material cutting apparatus comprising:
a frame including a first end and a second end, the frame having a track running between the first end and the second end;
a vertical support member mounted to the track and extending outwardly from the track, the vertical support member terminating at a vertical support member free end, wherein the vertical support member is configured to travel about the track from the first end to the second end, wherein the vertical support member is rotatable about a vertical axis that extends along a length of the vertical support member between the track and the vertical support member free end;
a cantilevered arm extending outwardly from and normal to the vertical support member, the cantilevered arm terminating at a cantilever free end; and
a cutting head configured to move along the cantilevered arm between the vertical support member and the cantilever free end, the cutting head including a rotational member configured to physically contact the material during material processing.

2. The cutting apparatus of claim 1, wherein the vertical support member is configured to rotate 180 degrees about the vertical axis such that the cantilevered arm can extend outwardly from a first side or a second side of the track.

3. The cutting apparatus of claim 1, wherein the rotational member is mounted directly below the cantilevered arm.

4. The cutting apparatus of claim 1, wherein the rotational member includes a blade.

5. The cutting apparatus of claim 1, wherein the rotational member includes a routing bit.

6. The cutting apparatus of claim 1, wherein the cutting head further includes a waterjet.

7. The cutting apparatus of claim 1, wherein the vertical support member includes radial bellows.

8. The cutting apparatus of claim 1, wherein the cutting head includes rotatable cable guides about a perimeter of the cutting head.

9. A material cutting apparatus comprising:
a frame including a first end and a second end, the frame having a track running between the first end and the second end;
a vertical support member mounted to the track and extending outwardly from the track, the vertical support member terminating at a vertical support member free end, wherein the vertical support member is configured to travel about the track from the first end to the second end, wherein the vertical support member is rotatable about an axis that extends along a length of the vertical support member between the track and the vertical support member free end;
a cantilevered arm extending outwardly from and normal to the vertical support member, the cantilevered arm terminating at a cantilever free end;
a cutting head including a cutting member configured to move along the cantilevered arm between the vertical support member and the cantilever free end; and
a control arrangement integrally mounted to the first end of the frame.

10. The material cutting apparatus of claim 9, wherein the control arrangement includes a control panel.

11. The material cutting apparatus of claim 9, wherein the control arrangement is attached to the material cutting apparatus using a mount.

12. The material cutting apparatus of claim 9, wherein the control arrangement includes a control screen.

13. The material cutting apparatus of claim 9, wherein the control arrangement facilitates remote control of the material cutting apparatus.

14. A material cutting apparatus comprising:
a frame including a first end and a second end, the frame having a track running between the first end and the second end;
a vertical support member mounted to the track and extending outwardly from the track, the vertical support member terminating at a vertical support member free end, wherein the vertical support member is configured to travel about the track from the first end to the second end, wherein the vertical support member is rotatable about an axis that extends along a length of the vertical support member between the track and the vertical support member free end;
a cantilevered arm extending outwardly from and normal to the vertical support member, the cantilevered arm terminating at a cantilever free end;
a cutting head including a cutting member configured to move along the cantilevered arm between the vertical support member and the cantilever free end; and
a modular worktable removably positioned at a first side of the frame, the modular worktable extending in a first direction at least partially along the frame between the first and second ends, the modular worktable extending outwardly away from the frame and normal to the vertical support member.

15. The material cutting apparatus of claim 14, wherein a second modular worktable is removably positioned at a second side of the frame, the second modular worktable extending in the first direction at least partially along the frame between the first and second ends, the second modular worktable extending outwardly away from the frame and normal to the vertical support member in an opposite direction from the first modular worktable.

16. The material cutting apparatus of claim 14, wherein the modular worktable further comprises:
a table frame;
a movable support surface pivotally mounted to the table frame, the support surface configured for supporting the material;
a first link extending between the support surface and the table frame, the first link pivotally connected to the support surface at a first end of the first link and pivotally connected to the table frame at a second end of the first link;
a second link extending between the support surface and the table frame, the second link pivotally connected to the support surface at a first end of the second link and pivotally connected to the table frame at a second end of the second link;
an actuator pivotally connected to the table frame, the actuator being configured to move the support surface between a generally horizontal position and a generally vertical position; and
a fluid tank positioned under the support surface.

17. The material cutting apparatus of claim 16, wherein the support surface pivots and translates with respect to the table frame when the support surface moves between the generally horizontal position and the generally vertical position.

18. The material cutting apparatus of claim 16, wherein the support surface includes a metallic grid positioned over the fluid tank when the support surface is in the generally horizontal position.

19. The material cutting apparatus of claim 16, wherein the modular worktable includes a pair of first links, a pair of second links, and a pair of actuators.

20. The material cutting apparatus of claim 19, wherein each actuator includes a ram, the rams being pivotally connected to the second links at locations between the first ends and the second ends of each second link.

21. A cutting apparatus comprising:
a frame including a first end and a second end, the frame having a track running between the first end and the second end;
a vertical support member mounted to the track and extending outwardly from the track, the vertical support member configured to travel about the track from the first end to the second end;
a cantilevered arm extending outwardly from and normal to the vertical support member, the cantilevered arm terminating at a cantilever free end; and
a cutting head configured to move along the cantilevered arm between the vertical support member and the cantilever free end, the cutting head configured to allow varying a cutting angle of a rotational member relative to the cantilevered arm, the rotational member configured to physically contact the material during material processing.
